(19) United States
(12) Patent Application Publication
(10) Pub. No.: US 2025/0328803 A1
(43) Pub. Date: Oct. 23, 2025

(54) Quantum Backpropagation and Dynamic Programming

(71) Applicant: Google LLC, Mountain View, CA (US)

(72) Inventors: Jarrod Ryan McClean, Underwood, WA (US); Amira Mahomed Abbas, Johannesburg (ZA)

(21) Appl. No.: 18/641,153

(22) Filed: Apr. 19, 2024

Related U.S. Application Data
(60) Provisional application No. 63/497,631, filed on Apr. 21, 2023.

(51) Int. Cl. G06N 10/60; G06N 10/20

(52) U.S. Cl. CPC G06N 10/60; G06N 10/20

(57) ABSTRACT

A method includes accessing qubits. Initial quantum states of the qubits encodes training data for a quantum machine learning model (QMLM). Final quantum states of the qubits are determined based on a quantum logic circuit (QLC) operating on the qubits. The QLC includes quantum logic gates. Each quantum logic gate performs a quantum operation on the qubits that is characterized by a model parameter. An offline model that corresponds to the QLC is initialized. The offline model is characterized by the model parameters. The offline model predicts evolved quantum states of the qubits at each quantum logic gate. The offline model is updated based on the final quantum states of the qubits. A value for each model parameter is determined based on a gradient that is based on the updated offline model.

### PRIORITY CLAIM

The present application claims priority to U.S. Provisional Application No. 63/497,631, entitled “QUANTUM BACKPROPAGATION AND DYNAMIC PROGRAMMING,” filed on Apr. 21, 2023, the contents of which are herein incorporated in their entirety.

### FIELD

The present disclosure relates generally to quantum computing systems, and more particularly to quantum backpropagation for quantum machine learning and quantum dynamic programming.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for training a quantum machine learning model that is characterized by a set of model parameters. The method includes accessing a set of qubits. A set of initial quantum states of the set of qubits encodes a set of training data for the quantum machine learning model. A set of final quantum states of the set of qubits is determined based on a quantum logic circuit (QLC) operating on the set of qubits. The QLC includes a set of quantum logic gates. Each quantum logic gate of the set of quantum logic gates performs a quantum operation on one or more qubits of the set of qubits. The quantum operation performed by a quantum logic gate of the set of quantum logic gates is characterized by a model parameter of the set of model parameters. An offline model that corresponds to the QLC is initialized. The offline model is characterized by the set of model parameters. The offline model is operable to predict an evolved set of quantum states of the set of qubits at each quantum logic gate of the set of quantum logic gates. The offline model is updated based on the set of final quantum states of the set of qubits. A value for each model parameter of the set of model parameters is determined based on a gradient that is based on the updated offline model.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2A depicts a flow diagram of an example method for training a quantum machine learning model that is characterized by a set of model parameters according to example embodiments of the present disclosure.

FIG. 2B depicts a flow diagram of an example method for updating an offline model based on a set of final quantum states, according to example embodiments of the present disclosure.

### DETAILED DESCRIPTION

Example aspects of the present disclosure are directed to enhanced systems and methods for backpropagation in a quantum machine learning application. Such quantum machine learning applications include, but are not otherwise limited to: image (and other digital object) classification tasks, classification of sentiment and textual analysis, analysis of high energy physics data, classification of data from a quantum sensor, quantum state discrimination, quantum repeater engineering, and the like. Thus, the embodiments have applications in the training of deep quantum networks for quantum data classification and identification, preparation of quantum states variationally for simulation, and the calculation of dynamic time correlators in quantum simulation for spectral fingerprinting.

The embodiments include a method for training parameterized quantum circuits and more generally reusing quantum information in a dynamic circuit to lower the overall costs of obtaining the gradients with respect to some loss function or the overlaps in a dynamic time series. Previous methods for obtaining the gradient scale were exponentially worse in the number of queries to an unknown initial state. Improving the scaling to linear, up to logarithmic, factors in the number of parameters was critical for the development of classical deep neural networks and was a decisive factor in the dominant architectures in modern machine learning. To that end, the embodiments provide scalable quantum backpropagation, and thus the development of quantum machine learning.

As noted above, the success of classical deep learning hinges on the ability to train classical neural networks at scale. Through reuse of intermediate information, classical backpropagation facilitates training through gradient computation at a total cost roughly proportional to running the classical function (e.g., a classical loss function), rather than incurring an additional factor proportional to the number of parameters-which can now be in the trillions. Naively, one expects that quantum measurement collapse entirely rules out the reuse of quantum information as in backpropagation or more general dynamic programming. However, some of the embodiments herein employ shadow tomography methods that have access to multiple copies of a quantum state. Via shadow tomography, the embodiments accomplish quantum backpropagation for training parameterized quantum models (e.g., for the embodiments that are directed to quantum machine learning via shadow tomography). Some embodiments achieve training of such quantum models as efficiently (or as nearly efficiently) as classical neural networks. With this added ability, some embodiments include an algorithm with foundations in “gentle” shadow tomography that matches backpropagation scaling in quantum resources, while reducing open shadow tomography problems for auxiliary classical computation. Thus, the embodiments make practical (e.g., efficient scalability) training of large quantum models practical.

Computing gradients through backpropagation is crucial to the success of modern, deep neural networks. Rather than a naive manifestation of the chain rule to compute gradients, backpropagation may leverage white-box knowledge of a computational graph, as well as intermediate values, to asymptotically improve runtimes. Computing the gradient of, say, a classical neural network function with respect to all its parameters, can be done at a total cost roughly proportional to running the function, instead of incurring an additional factor proportional to the number of parameters. This relative scaling, owed to backpropagation, has facilitated the training of very deep classical networks, with parameter counts now in order of 10¹⁰-accompanied with unparalleled empirical success. In this large-scale regime, classical models are known to have favorable training and generalization properties, which pushes deep neural networks forward as the leading models for many problems. When considering the number of function calls required to compute gradients, backpropagation in classical circuits may be exponentially more efficient with respect to the number of parameters than previous algorithms for determining gradients of parameterized quantum circuits—with or without the aid of a quantum computer. Nevertheless, the allure of large-scale models inspires the need for efficient training of parameterized quantum models, which frequently arise in fields like quantum machine learning and quantum chemistry. As noted above, the example embodiments provide the practicability of training large-scale parameterized quantum models.

The embodiments may be employed for training models with and without quantum memory, where the former is able to store a product of multiple copies of a particular state, to perform joint quantum operations followed by an entangled measurement. Whereas, training a model without quantum memory can perform operations on each copy, implement a (conditional) measurement, and use the resulting classical data.

Some embodiments employ “gentle” measurements. Such gentle measurements are useful in embodiments that employ shadow tomography. Briefly, shadow tomography techniques conserve quantum resources. In an information-theoretic sense, when access to multiple copies of a state is provided, some embodiments employ a modification of shadow tomography routines that provide backpropagation scaling if one restricts costs to the quantum overhead and ignores the classical cost incurred to implement known shadow tomography schemes.

A method for training parameterized quantum circuits is disclosed. The method includes reusing quantum information in a dynamic circuit to lower the overall costs of obtaining the gradients with respect to some loss function or the overlaps in a dynamic time series. Previous methods for obtaining the gradient scale were exponentially worse in the number of queries to an unknown initial state. Improving the scaling to linear, up to logarithmic. factors in the number of parameters was critical for the development of classical deep neural networks classically and was also a decisive factor in the dominant architectures in modern machine learning. The improvement in scaling (for quantum neural networks) provided by the embodiments provide practical quantum backpropagation and may have a similar influence in the development of quantum machine learning. Among others, this method has applications in the training of deep quantum networks for quantum data classification and identification, preparation of quantum states variationally for simulation, and the calculation of dynamic time correlators in quantum simulation for spectral fingerprinting.

More specifically, the method takes as input a data set of initial mixed quantum states {ρᵢ}, a parametric quantum circuit (e.g., a quantum logic circuit (QLC)) U(θ) that depends on the parameters {θⱼ}_{j=1,M} and a loss function L that may be defined as a Hermitian observable or function of the expected value of the observable, and may depend on data labels yⱼ (e.g., ground truth labels). The method outputs the value of the gradients of the loss function with respect to the parameters, that is ∂_{θ}_{ⱼ}L(θ), or the values of observable overlaps in the circuit, importantly with a number of calls to the unknown initial quantum state that scales polylog in the number of parameters M.

In some embodiments, data {ρᵢ} is provided in the most general case as an unknown set of quantum states. It may also be provided as a quantum logic circuit to be executed or a fixed known initial state, such as |000 . . . 0 [symbol] . The full quantum circuit may be run on k copies of the initial state ρᵢ, where k is determined by the desired precision e and has a logarithmic growth in the number of parameters M. This may constitute the forward pass of backpropagation. An offline classical model of the quantum state ρ̅_{M} in the final step may be initialized. The offline model may be an exact model, or an approximate model with a method of efficient updates such as a product state, matrix product state or tensor network state.

For each parameter of the gradient, the adjoint state may be unitarily updated using the subset of the circuit U^{†}, to correspond to the correct gradient. The classical model of the state offline may be unitarily updated using the definition of the circuit. If the offline model can be efficiently updated with low enough error, this is computationally efficient as well. A quantum private multiplicative weights shadow tomography algorithm may be run by using the quantum adjoint state in a gentle swap test to define the observable state, and update the current model of the state according to the algorithm there. In some embodiments, these could be either gradient components or time correlators in a time series. At the end of this procedure, both the original states modified only gently and estimates for the value of the gradient components to the desired precision or corresponding overlaps may be obtained.

One example aspect of the present disclosure is directed to a method for training a quantum machine learning model that is characterized by a set of model parameters. The method includes accessing a set of qubits. A set of initial quantum states of the set of qubits encodes a set of training data for the quantum machine learning model. A set of final quantum states of the set of qubits is determined based on a quantum logic circuit (QLC) operating on the set of qubits. The QLC includes a set of quantum logic gates. Each quantum logic gate of the set of quantum logic gates performs a quantum operation on one or more qubits of the set of qubits. The quantum operation performed by a quantum logic gate of the set of quantum logic gates is characterized by a model parameter of the set of model parameters. An offline model that corresponds to the QLC is initialized. The offline model is characterized by the set of model parameters. The offline model is operable to predict an evolved set of quantum states of the set of qubits at each quantum logic gate of the set of quantum logic gates. The offline model is updated based on the set of final quantum states of the set of qubits. A value for each model parameter of the set of model parameters is determined based on a gradient that is based on the updated offline model.

Applications of this method include most standard applications of classical machine learning but using quantum models, as well as examples from quantum machine learning that involve naturally quantum input data. Such applications include, but are not limited to, image and digit classification such as from MNIST or other sources of image/video data, classification of sentiment and textual analysis, analysis of high energy physics data, and classification of data from a quantum sensor into a phase. Applications of the embodiments also include quantum state discrimination or quantum repeater engineering, prediction using data from quantum sensors, many-body or otherwise, and determination of time-time correlation functions for spectral fingerprinting in chemical and material systems.

Aspects of the present disclosure provide a number of technical effects and benefits. For instance, the embodiments may provide a significant reduction in the computational complexity of backpropagation for quantum neural networks and quantum machine learning, including the determination and evaluation of a gradient for a loss function. That is, the embodiments may provide the practical determination of a gradient for quantum machine learning, which in turn may provide the practical implementation of quantum machine learning.

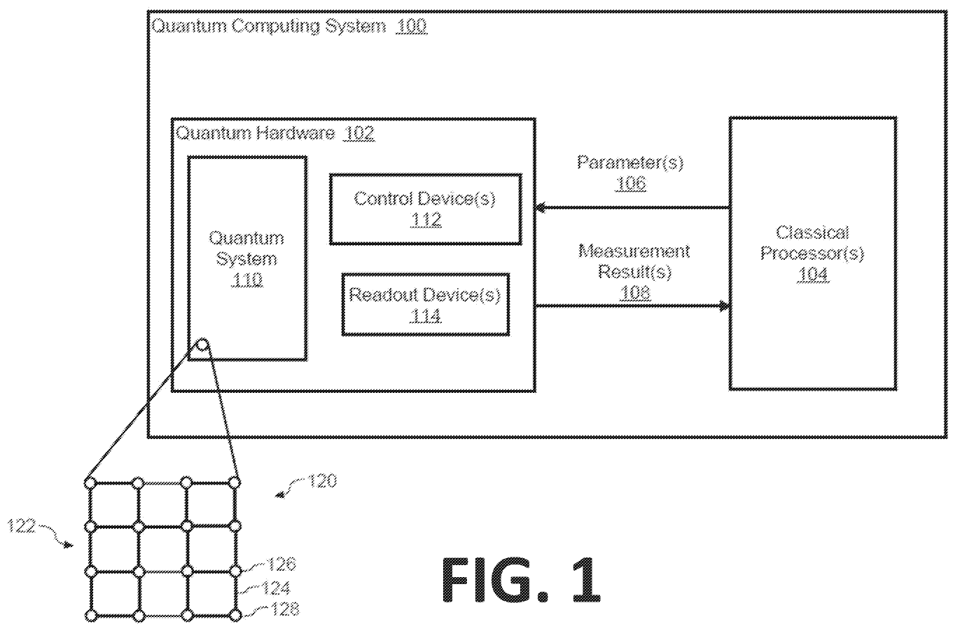

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum hardware 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameters 106 from the classical processors 104. The quantum hardware 102 may use the received physical control qubit parameters 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

### Backpropagation Scaling

A key advantage of gradient evaluation, given by automatic differentiation on classical computers, is that computational and memory resources that are employed to compute gradients of a function are bounded multiples of those used to compute the function. This bound is employed to define the requirements for backpropagation scaling.

Definition 1 (Backpropagation scaling). Given a parameterized function F(θ), where θ∈ [symbol] ^{M}, let F′(θ) be an estimate of the gradient vector accurate to within some constant & in the infinity norm. The total computational cost incurred to obtain F′(θ) with backpropagation is bounded such that:

$$TIME ( {F}^{′} ( θ ) ) \leq {c}_{t} \cdot TIME ( F ( θ ) ) , \qquad ( 1 )$$

$$and$$

$$MEMORY ( {F}^{′} ( θ ) ) \leq {c}_{m} \cdot MEMORY ( F ( θ ) ) , \qquad ( 2 )$$

where cₜ, cₘ= [symbol] (log (M)), and TIME(·) and MEMORY(·) capture the time and space complexity respectively for computing the function F or its gradient F′.

As a further specification of backpropagation scaling in Definition 1 above, one can specify whether one achieves this scaling in quantum resources, classical resources, or all resources. While it is, of course, the goal to achieve this scaling in all resources, the distinction remains relevant due to the ability to sometimes achieve the appropriate scaling in quantum resources by leaning on classical computation, which is elaborated on below in the “Reusing Multiple Copies Through Gentle Measurement” section. In classical models like neural networks, the overhead for both space and time can be constant, and typically by a small factor. This efficiency has been instrumental for training very large models and is arguably the main contributor to the success of modern classical machine learning. Given that variational quantum models, which utilize parameterized quantum circuits, are believed to be the most promising candidates to solve quantum machine learning tasks, their ability to reproduce this scaling is elaborated on below.

### Variational Quantum Models

Some embodiments employ variational algorithms to solve various optimization and machine learning problems on quantum devices. A non-limiting and slightly restricted model for ease of analysis which still covers a very broad range of practical scenarios is presented below.

Definition 2 (Simple variational model). Consider an initial quantum state ρ and a quantum circuit with M parameterized operations Uⱼ(θⱼ)=e^{-iθ}^{ⱼ}^{P}^{ⱼ}, where each Pⱼ is a Pauli operator acting on up to n qubits. A variational quantum model is defined as the below parameterized function:

$$F ( θ ) = Tr [ O ρ ( θ ) ] , \qquad ( 3 )$$

where O is a Hermitian and unitary observable, and the quantum state ρ(θ) is expressed as p(θ)=U(θ) ρU(θ)^{†}. In general, ρ is an unknown quantum state that refers to a quantum data setting. In a non-limiting simple case”

$${{ρ ( θ ) = \vert ψ ( θ ) 〉 〈 ψ ( θ ) \vert and \vert ψ ( θ ) 〉 = U ( θ ) \vert 0 〉}^{⊗ n} = {\prod }_{j = 1}^{M} {U}_{j} ( {θ}_{j} ) \vert 0 〉}^{⊗ n} .$$

In this simplified non-limiting case, the kth gradient components of F(θ) can be expressed as

$${[ {F}^{′} ( θ ) ]}_{{θ}_{k}} = - 2 I m 〈 0 \vert ( {\prod }_{j = 1}^{M} {e}^{i {θ}_{j} {P}_{j}} ) O ( {\prod }_{m = k + 1}^{M} {e}^{- i {θ}_{m} {P}_{m}} ) ( - i {P}_{k} ) ( {\prod }_{l = 1}^{k} {e}^{- i {θ}_{l} {P}_{l}} ) \vert 0 〉 . \qquad ( 4 )$$

Viewing this simple case, it becomes clear that computing all M components involves a large number of common operations. At face value, one might think it straightforward to exploit this overlap of operations to gain computational efficiency, as is done classically. However, as discussed in the next section, intermediate information in a quantum circuit may not easily retrievable without consequence.

### Learning Algorithms Without Quantum Memory

Recall that a learning algorithm without quantum memory would perform operations and measurements on each individual copy of a quantum state. In this regime, which is prominent in current quantum machine learning settings, the following proposition is relevant.

Proposition 3 (Backpropagation scaling is impossible for quantum data using single copies). Given the quantum data setting where one seeks to train a variational model using copies of the unknown state ρ and the additional constraint of no quantum memory, then backpropagation scaling is not possible in the general case.

Proof. Take the Pauli circuit model above and consider the case of all possible Pauli operators Pⱼ (for j=1,2,3,4) on n qubits, such that M=4ⁿ. If we take the special case of quantum data and initializing all θⱼ=0, then the gradient with respect to each of the parameters is given by the expected value of all possible Pauli operators on n qubits on the unknown quantum state p, up to a small constant. If no quantum memory is available, that is, we only have the ability to perform measurements on single copies at a time, then, the minimal number of copies of p is lower bounded by Ω(2ⁿ/ε²) in order to predict all Pauli operators to at most ε-error with probability 2/3. Hence, backpropagation scaling is not possible in general in the single copy case.

Notably, Proposition 3 is based on an information-theoretic separation that may not generalize to the simplified case of ρ=|0 [symbol] 0|, or even when ρ is simply guaranteed to be a pure state generated by a polynomial sized circuit. Hence, for the simplified case and polynomial complexity pure state cases, computational arguments may be employed. Furthermore, if it were possible to find a polynomial time algorithm, then it would be possible to efficiently clone pseudo-random states, which is not believed to be possible, despite the fact that they are pure states generated by polynomial sized circuits. The following remark aims to clarify the status of current methods for approaching this problem.

Remark 4 (Current gradient methods fail to achieve backpropagation scaling). Given a variational model F(θ) defined by F(θ)=Tr[Oρ(θ)], with time complexity:

$$TIME ( F ( θ ) ) = \tilde{𝒪} ( M / {ε}^{k} ) ,$$

for some integer k and precision ε, then all known schemes to estimate the gradient of F(θ) to the same precision, do not, in general, achieve a time complexity in line with backpropagation scaling.

Previous gradient methods fail. Some previous gradient algorithms require only a single black-box query to a function to estimate its full gradient with a desired precision. But, when considering variational models, a different query model must be applied and the original single-query advantage becomes unattainable. Lower bounds requiring a quantum computational cost of

$$𝒪 ( M \sqrt{M} / {ε}^{2} )$$

may be obtained. In a high precision regime,

$$𝒪 ( M \sqrt{M} / ε )$$

is worse-case optimal when using a black-box simplified model of U(θ). In other contexts, it has been previously argued that the simultaneous perturbation stochastic approximation (SPSA) algorithm is computationally efficient since it requires two function evaluations to estimate the gradient, irrespective of M. This seemingly satisfies the scaling required, however, as M increases, the variance of the gradient estimate increases and, thus, to counteract this, either a smaller learning rate must be used-increasing the number of optimization steps—or more samples are needed to estimate the gradient with an appropriate accuracy at every step. A sample complexity bound, which demonstrates SPSA's inability to exhibit backpropagation scaling, may be obtained. Thus far, other sampling schemes constructed to estimate the gradient of F(θ), like the parameter-shift rule, perform destructive measurements that typically only retrieve a partial amount of information for one component of the gradient. As a result, reducing the infinity norm error in the gradient with reasonable probability, has a cost that scales like converging each component, i.e.,

$$TIME ( {F}^{′} ( θ ) ) ∝ M \cdot TIME ( F ( θ ) ) \qquad ( 5 )$$

$$= \tilde{𝒪} ( {M}^{2} / {ε}^{k} ) , \qquad ( 6 )$$

which may not achieve backpropagation scaling. While this quadratic dependence on the number of parameters may not seem problematic, a linear dependence was the necessary catalyst in the age of modern deep learning, with over-parameterized networks that perform exceedingly well on practical tasks.

Proposition 5 (Classical analogue achieves backpropagation scaling). Parameterized Markov chains, which are much closer classical analogues to variational models than neural networks, exhibit backpropagation scaling.

Under some reasonable assumptions on the set of classical operations, the desired scaling is indeed possible in analogous classical parameterized stochastic processes. The formulation of this classical-quantum analogy allows one to probe the root cause of why backpropagation scaling is so difficult to obtain in the quantum variational setting. The origin of the challenge lies within quantum measurement collapse and the inability to read out intermediate states while continuing a computation, rather than the probabilistic formulation of the problem. In the classical setting, one is always promised to be in a computational basis state, making it possible to do perfect measurements non-destructively at intermediate steps.

Although Proposition 3 presents a strict lower bound ruling out backpropagation in the quantum data case with single copies, some embodiments have access to multiple copies of a quantum state and achieves practical backpropagation scaling via the multiple copies. Moreover, destructive quantum measurements are the inhibitor of backpropagation scaling in single copies. Some embodiments achieve scalable backpropagation via a middle ground where one could perform measurements that are only partially destructive on multiple copies. The next section discusses these embodiments.

### Reusing Multiple Copies Through Gentle Measurement

Given that classical backpropagation thrives on information reuse and classical analogues to variational circuits exploit the same ability, some embodiments employ gentle measurements to reuse quantum resources in order to achieve backpropagation scaling.

Definition 6 (Gentle measurement). Fix a subset of quantum mixed states [symbol] . A measurement F is α-gentle on [symbol] if for every state ρ∈ [symbol] , and every outcome y of F, the post-selected state ρ_{F=y} obeys

$$‖ {ρ}_{F = y} - ρ ‖ \leq α ,$$

where α∈[0,1]. Hence, the smaller the α, the less damage incurred by ρ.

By allowing access to multiple copies of ρ, the gentle measurements facilitate backpropagation scaling, contrary to the single copy case outlined in Proposition 3. In particular, a method can be used to determine all M gradient components of the function specified in equation 3 with efficient offline classical computation, by taking advantage of a combination of properties of Pauli operators and ideas from gentle measurements using multiple copies, which is considered within the scope of backpropagation scaling.

Proposition 7 (A special case variational model achieves backpropagation scaling).

$$Given a variational model F ( θ ) = Tr [ U ( θ ) ρ {U ( θ )}^{†} ] , where U ( θ ) {\prod }_{j = 1}^{M} {e}^{- i {θ}_{j} {P}_{j}} V for some fixed unitary V , setting θ to zero and O = 1 , the {k}^{th} gradient component may be written as {{F}^{′} ( 0 )}_{k} = - 2 Im ( Tr [ V ρ {V}^{†} ( - i ) ] {P}_{k} ) = 2 R e ( Tr [ V ρ {V}^{†} {P}_{k} ] ) . \qquad ( 7 )$$

Then all M gradient components can be estimated to within a fixed precision ε using

$$𝒪 ( log ( M ) / {ε}^{4} ) .$$

function calls, and thus:

$$TIME ( {F}^{′} ( θ ) ) = 𝒪 ( log ( M ) ) TIME ( F ( θ ) ) ,$$

which is in line with backpropagation scaling.

Proof: By restricting to Pauli operators, one may estimate the magnitude of all gradient components with O(log M/ε⁴) copies of p via application of V and two-copy Bell measurements of the resulting states that harness gentleness. Similarly, using O(log (M)/ε²) copies along with the magnitude information from the Bell measurements, one may estimate the sign of the gradient components using a majority vote scheme that also exploits gentleness. The total number of copies scales as O(log (M)/ε⁴), inducing a time complexity of O(log (M) M/ε⁴).

This result indicates that there are at least some choices of circuits and generators for which backpropagation scaling can be achieved using gentle measurements. This is possible in more general cases with techniques like shadow tomography. In the next section, it is shown how to use shadow tomography results to obtain quantum backpropagation efficiency for unknown quantum data.

### A Quantum-Efficient Protocol for Backpropagation

For the general quantum data setting with multi-copy access, a connection between gradient estimation and shadow tomography is shown below. This connection (which at least some embodiments employ) provides an exponential improvement to the sample complexity of the input state from [symbol] (M) to [symbol] (polylog M) for computing gradients. It also provides a quadratic improvement in the number of quantum operations from [symbol] (M²) to [symbol] (M), analogous to classical backpropagation. Some embodiments employ classical storage and manipulation of a hypothesis state, which may result in an exponential classical overhead. In some embodiments, an approximation scheme may be effectively applied to overcome the exponential classical overhead. The exponential saving in sample complexity may be important in settings where the labelled quantum states coming from nature are limited, and valuable. Further, the linear scaling of quantum operations, even in the face of exponential classical overhead, could be beneficial when classical computation is extremely cheap when compared to quantum computation.

Some embodiments apply an even more general model than equation 3, which may be referred to as a quantum neural network and is defined below.

Definition 8 (Quantum neural network). Let a quantum neural network be a variational quantum circuit on n+1 qubits, numbered 0, 1, . . . , n. Qubits 1, . . . , n act as the data register, which will take as input an unknown quantum state |φ [symbol] to be classified. Qubit 0 acts as the output register, which is measured in the Z-basis and initialized to |0 [symbol] . The variational circuit belongs to the following simple class

$$𝒰 ( \vec{θ} ) = {e}^{i {θ}_{M} {P}_{M}} {U}_{M} … . {e}^{i {θ}_{1} {P}_{1}} {U}_{1} ,$$

where {Pₖ} are fixed (n+1)-qubit Pauli operators and {Uₖ} are fixed circuits. The output prediction on |φ [symbol] is then given by a quantum neural network function defined as

$${QNN}_{\vec{θ}} ( \vert φ 〉 ) = 〈 0 \vert 〈 φ \vert {𝒰}^{†} ( \vec{θ} ) {Z}_{0} 𝒰 ( \vec{θ} ) \vert 0 〉 \vert φ 〉 ∈ [ - 1 , 1 ] \qquad ( 8 )$$

Note that running the circuit on [symbol] 0| [symbol] φ| gives a coin flip

$$Ber ( \frac{1}{2} + \frac{1}{2} {QNN}_{\vec{θ}} ( \vert φ 〉 ) )$$

rather than on QNN_{\vec{θ}}(|φ [symbol] ) itself. This allows one to estimate QNN_{\vec{θ}}(|φ [symbol] ) to ε precision with high probability by running the circuit poly (ε⁻¹) times, as usual. Theorem 9 follows.

Theorem 9 (Quantum-efficient backpropagation). There exists an explicit algorithm which produces estimates bₖ for all k=1, . . . , M such that

$$\vert {b}_{k} - \frac{1}{2} {\partial }_{{θ}_{k}} {QNN}_{\vec{θ}} ( \vert φ 〉 ) \vert \leq ε using only copies of \vert φ 〉 .$$

$$m = 𝒪 ( \frac{{( log M )}^{2} {n}^{2}}{{ε}^{8}} )$$

Proof. It is first shown that estimating the gradient component ∂_{θ}_{ₖ}QNN_{\vec{θ}}(|φ [symbol] ) reduces to estimating the expectation value of a certain traceless Hermitian unitary operator on |+ [symbol] 0 [symbol] |φ [symbol] . Shadow tomography results then imply that estimating all gradient components to precision ε is possible using only poly(log M, n, ε⁻¹) copies of |φ [symbol] . In order to fully specify the algorithm, an adapted and improved shadow tomography protocol is employed by some embodiments. Namely the quantum private multiplicative weights algorithm (QPMW), that makes use of gentle measurements may be employed. By harnessing the gentle and online nature of QPMW, the M gradient components may be measured with one “forward pass” of the quantum neural network.

Remark 10 (Cost incurred by shadow tomography protocol for gradients). The required number of quantum operations for the proposed algorithm in Theorem 9 is [symbol] (nM), which is quasi-linear in M. However, naive storage of the entire density matrix of the hypothesis state incurs a classical cost of M· [symbol] , which is also linear in M, but unfortunately exponential in the input size n when no special case or effective approximation schemes are known.

### Reduction From Shadow Tomography

The discussion now turns to a fully efficient algorithm for computing gradients that gives rise to a fully efficient shadow tomography procedure for observables. It is also shown that the algorithm can be efficiently implemented.

Definition 11 (Shadow tomography problem). Let ε be a class of two-outcome measurements with outcomes in {±1}. Given an unknown n-qubit quantum state |ψ [symbol] , and known measurements E₁, . . . , E_{M} ∈ E, output estimates b₁, . . . , b_{M} ∈ [−1, 1] such that |bₖ− [symbol] ψ|Eₖ|ψ [symbol] |≤ε∀k. In particular, do this via a measurement of |ψ [symbol] ⊗m where m is as small as possible.

Definition 12 (Poly-time observables). A poly-time observable on n qubits is defined to be an observable of the form U^{†}Z₁U where U is a poly-size circuit.

There are indeed cases where this problem may produce a favorable scaling in M and n, as outlined in Proposition 7.

Theorem 13 (Shadow tomography reduction). Suppose there is an algorithm which can estimate the gradients ∂_{θ}_{ₖ}QNN_{θ̅}(|ψ [symbol] ), k=1, . . . , M, to precision ε, with, copies of |ψ [symbol] , and with runtime T. Then, this gives an algorithm for shadow tomography of poly-time observables, to precision

$$\frac{ε}{2}$$

with m copies of |ψ [symbol] and runtime T.

Proof: Consider an instance of shadow tomography on n qubits, with E₁, E₂, . . . , E_{M} given by Eₖ=Uₖ^{†}Z₁Uₖ, where {Uₖ} are poly-size circuits. Construct the quantum neural network with the following variational circuit:

$$𝒰 ( \vec{θ} ) \vert 0 〉 \vert ψ 〉 = {e}^{i {θ}_{M} {Y}_{0} ⊗ {Z}_{1}} {U}_{M} … {e}^{i {θ}_{1} {Y}_{0} ⊗ {Z}_{1}} {U}_{1} {H}_{0} \vert 0 〉 \vert ψ 〉 = {e}^{i {θ}_{M} {Y}_{0} ⊗ {Z}_{1}} {U}_{M} … {e}^{i {θ}_{1} {Y}_{0} ⊗ {Z}_{1}} {U}_{1} {H}_{0} \vert ψ 〉$$

$$where$$

$${\hat{U}}_{1} = {0}_{} ⊗ {U}_{1}$$

$${\hat{U}}_{k} = {𝕀}_{0} ⊗ {U}_{k} {U}_{k - 1}^{†} , 1 < k \leq M .$$

Then, following equation (7), the gradients at \vec{θ}=\vec{0} are

$${\partial }_{{θ}_{k}} {QNN}_{\vec{θ}} ( \vert ψ 〉 ) {\vert}_{\vec{θ} = \vec{θ}} = 2 R e 〈 0 \vert 〈 ψ \vert {𝒰}^{†} ( \vec{0} ) {Z}_{0} {\partial }_{{θ}_{k}} 𝒰 ( \vec{0} ) \vert 0 〉 \vert ψ 〉 = 2 〈 ψ \vert {E}_{k} \vert ψ 〉 .$$

Thus, computing the gradients allows one to solve the shadow tomography instance.

### A Fully Gentle Gradient Strategy

Since shadow tomography makes use of multiple copies and an offline classical model to require a minimal number of destructive measurements, it is useful to examine the limits of gentle measurement alone for gradient estimation in order to reduce the classical overhead. In particular, it would be ideal if it were possible to use a small number of copies (e.g. polylog (1/α)) of a quantum state, to achieve α-gentleness in the general case through a simple, direct measurement scheme. This capability provides a scheme for gradient estimation that achieves backpropagation scaling. This capability also enables one to violate known query lower bounds for the unstructured search problem. Thus, for gradient purposes, it seems as if successful schemes may limit the number of potentially destructive accesses to the quantum state via use of an offline model. The general failure of gentle measurement alone is formalized in the following theorem.

Theorem 14 (Repeated gentle measurements). Assume it is possible to perform an arbitrary two-outcome measurement gently by using up to a polylogarithmic number of copies of the state. Specifically, assume that any measurement can be made α-gentle by using [symbol] (polylog (1/α)) copies of the state. Such an ability leads to a violation of known query bounds given by Grover's search algorithm, and thus, cannot be possible in general.

Proof. Consider the n-qubit Grover state after I iterations with an ancilla present to mark the state |x

[symbol]

$$sin ( ( 2 i + 1 ) θ ) \vert x 〉 \vert 1 〉 + cos ( ( 2 i + 1 ) θ ) {\sum }_{y ∈ {\{ 0 , 1 \}}^{n}} {2}^{- \frac{M - 1}{2}} \vert y 〉 \vert 0 〉 , \qquad ( 9 )$$

where

$$θ = arcsin {2}^{- \frac{M}{2}} .$$

For each of the M=2ⁿ possible marked elements x, one can define a two-element POVM of the form {|x [symbol] |1 [symbol] x| [symbol] 1|, I−|x [symbol] |1 [symbol] x| [symbol] 1|}. One may ensure that the marked bit string is found with high probability by performing a measurement of each of these POVMs with respect to the Grover state [symbol] (2ⁿ) times, even in the case where the state is constructed with a single Grover oracle query. Performing this procedure using standard, destructive, measurements of the POVMs would require a fresh set of oracle queries with each round. However, using sufficiently gentle measurements removes this requirement. If the distance between the pre- and post-measurement states is sufficiently small, one obtains results that are close to those that one would obtain from a fresh copy of the state. In order to guarantee that the marked bit string can be extracted with high probability, one must ensure that the state obtained after any number of measurement rounds be within a distance

$$\frac{{2}^{- n}}{3}$$

of the state prior to any measurements. In order to guarantee that the state be sufficiently unchanged by the end of the series of [symbol] (2⁻²ⁿ) measurements, each measurement should therefore be [symbol] (2⁻³ⁿ) gentle. By assumption, this is possible with polylog (2³ⁿ) or simply poly(n), copies of the original state, each of which is prepared using the Grover oracle a set number of times. By performing the whole sequence of measurements gently, one can avoid biasing the result too much before the marked state is found. Hence, one can identify x with high probability, using poly(n) 2^{n/2} Grover oracle calls, which is a violation of known lower bounds.

Remark 15 (Shadow tomography does not violate known bounds). After seeing this result, one might question how this relates to shadow tomography schemes that make use of gentle measurement, plus offline computation. It is consistent when one considers that α-gentleness considered in isolation must apply to both the number of distinct measurements one may perform and the precision to which one performs a particular repeated measurement. That is, from the point of view of gentle measurement alone, gentleness on different measurements and gentleness on repeated measurement to high precision &, are on the same footing and hence, must respect known bounds for information extraction. Indeed, all known shadow tomography schemes are consistent with the number of copies of the state scaling polynomially with ε, despite scaling logarithmically in the number of distinct measurements, which prevents the above violation of known Grover query and time complexity bounds. This reflects an asymmetry between number of distinct measurements and precision of a single measurement present in all shadow tomography schemes. It has been hypothesized that there are fewer independent observables within a quantum state than one might expect intuitively. The success of shadow tomography schemes, as distinct from simple gentle measurement, depends crucially on the existence of models that update quickly enough to limit that number of measurements to the actual quantum states (in contrast to the model) to a very small number.

### Approximate Schemes

As noted, some embodiments may employ an offline classical model to provide backpropagation scaling. A challenge in the general application of the proposed shadow tomography algorithm is the use of an explicit offline representation of the quantum state, which in general, scales exponentially with system size. It has been shown that the embodiments achieve determining the gradient components for some functions (e.g., functions based on Pauli operators of constant depth) is computationally efficient. Other embodiments may use approximate offline representations of the state. For example, in cases where states exhibit low entanglement, they may be efficiently represented by matrix product or tensor network states. Moreover, in the case of shadow tomography, one may not be explicitly seeking an exact representation of the density matrix, but rather a proxy, capable of reproducing the desired observables with high probability. This relaxation of requirements may render an approximation scheme effective, even when the true state is challenging to represent with a particular ansatz. This allows for a dramatic increase of efficiency of training in quantum machine learning models.

### Example Methods

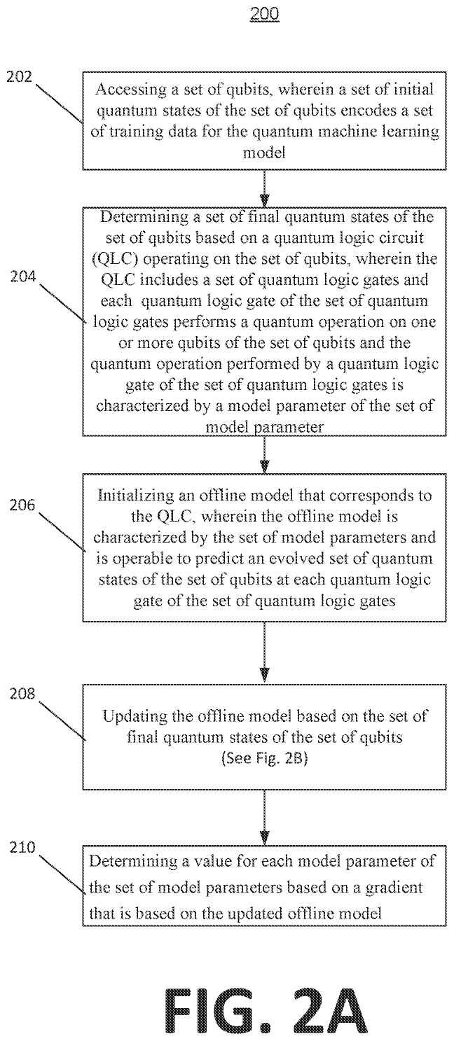

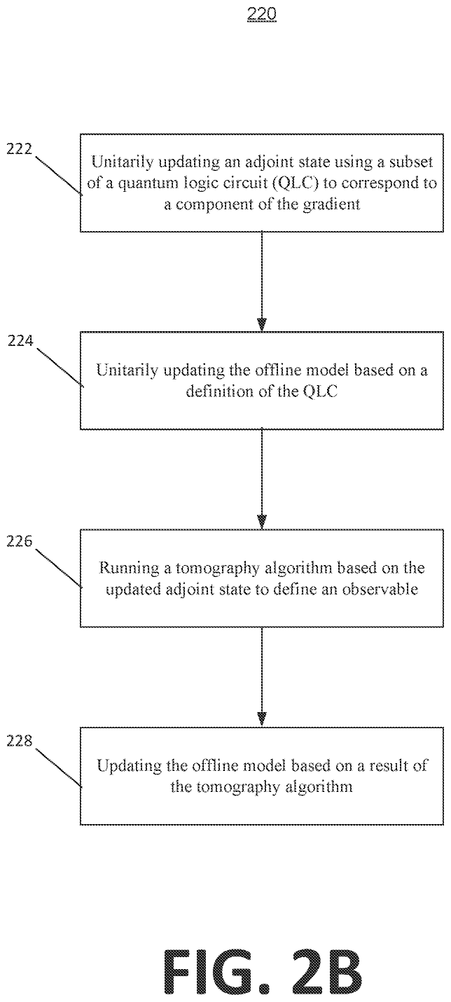

FIGS. 2A-2B depict operations performed in a particular order for purposes of illustration and discussion. Those of ordinary skill in the art, using the disclosures provided herein, will understand that operations of any of the methods described herein can be expanded, include steps not illustrated, omitted, rearranged, and/or modified in various ways without deviating from the scope of the present disclosure. Method 200 of FIG. 2A and method 220 of FIG. 2B may be implemented using any suitable quantum computing system, such as the system described in FIG. 1. As used herein, the term “computing devices” can refer to a classical computing device, quantum computing device, or combination of classical and quantum computing devices

FIG. 2A depicts a flow diagram of an example method 200 for training a quantum machine learning model that is characterized by a set of model parameters according to example embodiments of the present disclosure. Method 200 begins at block 202, where a set of qubits is accessed. A set of initial quantum states of the set of qubits encodes a set of training data for the quantum machine learning model. At block 204, a set of final quantum states of the set of qubits is determined. Determining the set of final states may be based on a quantum logic circuit (QLC) operating on the set of qubits. The QLC includes a set of quantum logic gates. Each quantum logic gate of the set of quantum logic gates performs a quantum operation on one or more qubits of the set of qubits. The quantum operation performed by a quantum logic gate of the set of quantum logic gates may be characterized by a model parameter of the set of model parameters. At block 206, an offline model that corresponds to the QLC is initialized. The offline model may be characterized by the set of model parameters. The offline mode may be operable to predict an evolved set of quantum states of the set of qubits at each quantum logic gate of the set of quantum logic gates. At block 208, the offline model that corresponds to the QLC (or the quantum machine learning model) is updated based on the set of final quantum states of the set of qubits. Various embodiments of updating an offline model are discussed in conjunction with method 220 of FIG. 2B. At block 210, a value for each model parameter of the set of model parameters is determined based on a gradient that is based on the updated offline model.

FIG. 2B depicts a flow diagram of an example method 220 for updating an offline model based on a set of final quantum states, according to example embodiments of the present disclosure. Method 220 begins at block 222, where an adjoint state is unitarily updated using a subset of a quantum logic circuit (QLC) to correspond to a component of the gradient. At block 224, the offline model is unitarily updated based on a definition of the QLC. At block 226, a tomography algorithm is run based on the updated adjoint state to define an observable. At block 228, the offline model is updated based on a result of the tomography algorithm.

### Additional Embodiments

One example aspect of the present disclosure is directed to a method for training a quantum machine learning model that is characterized by a set of model parameters. The method includes accessing a set of qubits. A set of initial quantum states of the set of qubits encodes a set of training data for the quantum machine learning model. A set of final quantum states of the set of qubits is determined based on a (QLC) operating on the set of qubits. The QLC includes a set of quantum logic gates. Each quantum logic gate of the set of quantum logic gates performs a quantum operation on one or more qubits of the set of qubits. The quantum operation performed by a quantum logic gate of the set of quantum logic gates is characterized by a model parameter of the set of model parameters. An offline model that corresponds to the QLC is initialized. The offline model is characterized by the set of model parameters. The offline model is operable to predict an evolved set of quantum states of the set of qubits at each quantum logic gate of the set of quantum logic gates. The offline model is updated based on the set of final quantum states of the set of qubits. A value for each model parameter of the set of model parameters is determined based on a gradient that is based on the updated offline model.

Updating the offline model may include unitarily updating an adjoint state using a subset of the QLC to correspond to a component of the gradient. The offline model may be unitarily updated based on a definition of the QLC. A tomography algorithm may be executed (or run) based on the updated adjoint state to define an observable. The offline model may be updated based on a result of the tomography algorithm. The result of the tomography algorithm may include one or more components of the gradient. The result of the tomography algorithm may include one or more time correlators in a time series. The tomography algorithm may be a quantum private multiplication weights shadow tomography algorithm. Executing (or running) the tomography algorithm may include using quantum states in a gentle swap test to define the observable.

The offline model may be an approximate model with a method of efficient updates. The method of efficient updates may include a product state. The method of efficient updates may include a matrix product state. The method of efficient updates may include a tensor network state.

In some embodiments, the offline model is an exact model. The offline model may be a classical model. Each atom of the set of training data may include a ground-truth label. An evaluation of the loss function may be based on the ground-truth label for at least a subset of the set of training data. The QLC operating on the set of qubits may include the QLC operating on multiple sets of qubits that encode multiple copies of the set of training data.

The method may include deploying the quantum machine learning model for a task based on the determined value for each model parameter. The task may include at least one of an image classification task, a textual sentiment task, an analysis of particle scattering data, a classification of quantum sensor data, a quantum state discrimination task, a prediction task, or a determination of time-time correlation functions.

One embodiment includes a quantum computing system (QCS). The QCS includes a set of qubits and a quantum logic circuit (QLC). The QLC may include a set of quantum logic gates. The QCS includes one or more processor devices and one or more memory devices that store computer readable instructions. When computer readable instructions are executed by the one or more processor devices, it may cause the one or more processor devices to perform operations for training a quantum machine learning model that is characterized by a set of model parameters. The operations include accessing a set of qubits. A set of initial quantum states of the set of qubits encodes a set of training data for the quantum machine learning model. A set of final quantum states of the set of qubits is determined based on a QLC operating on the set of qubits. Each quantum logic gate of the set of quantum logic gates performs a quantum operation on one or more qubits of the set of qubits. The quantum operation performed by a quantum logic gate of the set of quantum logic gates is characterized by a model parameter of the set of model parameters. An offline model that corresponds to the QLC is initialized. The offline model is characterized by the set of model parameters. The offline model is operable to predict an evolved set of quantum states of the set of qubits at each quantum logic gate of the set of quantum logic gates. The offline model is updated based on the set of final quantum states of the set of qubits. A value for each model parameter of the set of model parameters is determined based on a gradient that is based on the updated offline model.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for training a quantum machine learning model that is characterized by a set of model parameters, the method comprising:
accessing a set of qubits, wherein a set of initial quantum states of the set of qubits encodes a set of training data for the quantum machine learning model;
determining a set of final quantum states of the set of qubits based on a quantum logic circuit (QLC) operating on the set of qubits, wherein the QLC includes a set of quantum logic gates and each quantum logic gate of the set of quantum logic gates performs a quantum operation on one or more qubits of the set of qubits and the quantum operation performed by a quantum logic gate of the set of quantum logic gates is characterized by a model parameter of the set of model parameters;
initializing an offline model that corresponds to the QLC, wherein the offline model is characterized by the set of model parameters and is operable to predict an evolved set of quantum states of the set of qubits at each quantum logic gate of the set of quantum logic gates;
updating the offline model based on the set of final quantum states of the set of qubits; and
determining a value for each model parameter of the set of model parameters based on a gradient that is based on the updated offline model.

2. The method of claim 1, wherein updating the offline model comprises:
unitarily updating an adjoint state using a subset of the QLC to correspond to a component of the gradient;
unitarily updating the offline model based on a definition of the QLC; and
executing a tomography algorithm based on the updated adjoint state to define an observable; and
updating the offline model based on a result of the tomography algorithm.

3. The method of claim 2, wherein the result of the tomography algorithm includes one or more components of the gradient.

4. The method of claim 2, wherein the result of the tomography algorithm includes one or more time correlators in a time series.

5. The method of claim 2, wherein the tomography algorithm is a quantum private multiplication weights shadow tomography algorithm.

6. The method of claim 2, wherein executing the tomography algorithm includes using quantum states in a gentle swap test to define the observable.

7. The method of claim 1, wherein the offline model is an approximate model with a method of efficient updates.

8. The method of claim 7, wherein the method of efficient updates includes a product state.

9. The method of claim 7, wherein the method of efficient updates includes a matrix product state.

10. The method of claim 7, wherein the method of efficient updates includes a tensor network state.

11. The method of claim 1, wherein the offline model is an exact model.

12. The method of claim 1, wherein the offline model is a classical model.

13. The method of claim 1, wherein each atom of the set of training data includes a ground-truth label.

14. The method of claim 13, wherein an evaluation of the loss function is based on the ground-truth label for at least a subset of the set of training data.

15. The method of claim 1, wherein the QLC operating on the set of qubits includes the QLC operating on multiple sets of qubits that encode multiple copies of the set of training data.

16. The method of claim 1, further comprising:
deploying the quantum machine learning model for a task based on the determined value for each model parameter.

17. The method of claim 16, wherein the task includes at least one of an image classification task, a textual sentiment task, an analysis of particle scattering data, a classification of quantum sensor data, a quantum state discrimination task, a prediction task, or a determination of time-time correlation functions.

18. A quantum computing system (QCS), comprising:
a set of qubits
a quantum logic circuit (QLC);
one or more processor devices;
one or more memory devices, the one or more memory devices storing computer-readable instructions that when executed by the one or more processor devices cause the one or more processor devices to perform operations for training a quantum machine learning model that is characterized by a set of model parameters, the operations comprising:
accessing a set of qubits, wherein a set of initial quantum states of the set of qubits encodes a set of training data for the quantum machine learning model;
determining a set of final quantum states of the set of qubits based on a quantum logic circuit (QLC) operating on the set of qubits, wherein the QLC includes a set of quantum logic gates and each quantum logic gate of the set of quantum logic gates performs a quantum operation on one or more qubits of the set of qubits and the quantum operation performed by a quantum logic gate of the set of quantum logic gates is characterized by a model parameter of the set of model parameters;
initializing an offline model that corresponds to the QLC, wherein the offline model is characterized by the set of model parameters and is operable to predict an evolved set of quantum states of the set of qubits at each quantum logic gate of the set of quantum logic gates;
updating the offline model based on the set of final quantum states of the set of qubits; and
determining a value for each model parameter of the set of model parameters based on a gradient that is based on the updated offline model.

19. The QCS of claim 18, wherein updating the offline model comprises:
unitarily updating an adjoint state using a subset of the QLC to correspond to a component of the gradient;
unitarily updating the offline model based on a definition of the QLC; and
executing a tomography algorithm based on the updated adjoint state to define an observable; and
updating the offline model based on a result of the tomography algorithm.

20. The QCS of claim 18, wherein the operations further comprise:
deploying the quantum machine learning model for a task based on the determined value for each model parameter, wherein the task includes at least one of an image classification task, a textual sentiment task, an analysis of particle scattering data, a classification of quantum sensor data, a quantum state discrimination task, a prediction task, or a determination of time-time correlation functions.
